(19) United States
(12) Patent Application Publication
(10) Pub. No.: US 2008/0081089 A1
(43) Pub. Date: Apr. 3, 2008

(54) Package for Brewing a Substance to be Brewed

(75) Inventor: Jean-Pierre Blanc, Nice (FR)

Correspondence Address: YOUNG & THOMPSON, 745 SOUTH 23RD STREET, 2ND FLOOR, ARLINGTON, VA, 22202, US

(73) Assignee: COMPAGNIE MEDITERRANEENNE DES CAFES S.A., CARROS (FR)

(21) Appl. No.: 11/659,735

(22) PCT Filed: Jul. 26, 2005
(86) PCT No.: PCT/EP05/53646

§ 371 Date: Feb. 8, 2007

(30) Foreign Application Priority Data
Aug. 10, 2004 (FR) 0451833

(51) Int. Cl. B65B 29/02; A47J 31/06

(52) U.S. Cl. 426/77; 99/323

(57) ABSTRACT

A package (1) for brewing a substance to be brewed includes two superimposed filter paper layers (2, 3) defining a volume for receiving the substance to be brewed (4) and each integral with a peripheral reinforcing surface (5), the package (1) including a mark for identification. The invention is characterized in that the marking is performed on at least one surface of the peripheral reinforcement (5).

The present invention concerns a package for brewing a substance to be brewed.

Its particular application will be found in packages of ground coffee for use in coffee machines which use pre-packaged doses of ground coffee.

Doses of this type are found in this applicant's document WO-A-95 07041.

According to this prior art, two layers of filter paper-based are superimposed to create a residual interstitial volume which receives the ground coffee.

The periphery of the layers are joined to a peripheral reinforcement so as to render the assembly rigid.

Publication WO-A02/28241 forms part of this technique and proposes moreover the creation of a package identification such as a bar code, a specific shape or a mark of a particular colour.

This identification is able to co act with reading means on the coffee machine.

The type of doses can be identified to allow or not the start of a brewing operation and to adjust the brewing parameters (temperature, duration).

The type of identification envisaged by WO-A-02/28241 does not give entire satisfaction.

Indeed, when they are in the form of a cutout, they are difficult and expensive to manufacture in series and the use of the doses is less practical and less ergonomic.

As to the printing of the bar code, the presence of printing inks is not very compatible with food standards.

The bar codes also pose problems of reading insofar as they do not cover all the periphery of the package.

The present invention has the characteristic of providing the marking on the peripheral reinforcement.

An advantage of this arrangement is that it is better able to satisfy the food standards, in particular by avoiding any use of printing inks on the filter paper-based used to constitute the layers of the package.

According to a preferred embodiment, the marking is a colour code applied on or in the reinforcement, which clearly facilitates manufacture.

In particular, colouring of the reinforcement is sufficient to identify the package on all its periphery and on both sides.

Other aims and advantages will become apparent in the description of the preferred embodiment which follows, but which is not restrictive.

The present invention concerns a package for brewing a substance to be brewed and comprises two layers of filter paper-based superimposed so as to define a volume which receives the substance to be brewed, and joined each one on one side of a peripheral reinforcement, the said package having marking for its identification, characterized in that the marking is carried out on at least one side of the peripheral reinforcement.

According to preferred variants, this package is such that:

the reinforcement has a rigid core covered on both sides by a polymer plastic coating

the marking is of a predefined colour of the material used for at least one of the reinforcement coatings

the marking takes place on at least one side of the rigid core.

the marking is a continuous strip of predefined colour on at least one side of reinforcement.

the length of the strip is equal to that of reinforcement.

the marking is a predefined colour of the rigid core material.

the marking is a predefined colour of the peripheral reinforcement material.

the peripheral reinforcement is non opaque.

The attached drawings are given as examples and are not restrictive. They show only one embodiment of the invention and will help to make easily understood.

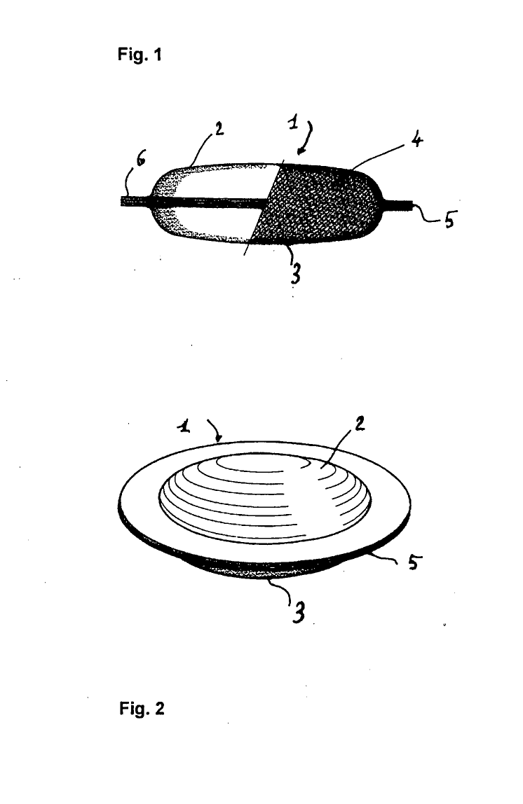

FIG. 1 shows a partial side view and a partial sectional view of a package according to the invention.

FIG. 2 gives a perspective view of it.

As shown on FIGS. 1 and 2, a package 1 of roughly saucer shape which is symmetrically round can be used.

However, this configuration is not restrictive and in particular packages 1 with a square section can be used.

Package 1 of the invention shows an upper layer 2 using filter paper-based and a lower layer 3 advantageously of the same composition and able to define an inner volume filled with a substance to be brewed 4.

In a preferred example, substance 4 is ground coffee.

Ground coffee 4 is enclosed in package 1 by adjoining the periphery of layers 2, 3 forming a peripheral seal 6.

At peripheral seal 6, layers 2, 3 are joined to reinforcement 5 which increases the rigidity of the assembly.

Reinforcement 5 can also improve joining of layers 2, 3.

In a preferred example, peripheral reinforcement 5 includes a central core in cardboard, the said central core being covered on both sides by a polymer plastic coating.

Substance 4 to be brewed is preferably ground coffee, but the substance passing through the filter can also be a cleaning compound comprising a detergent product in spray or solid tablet form.

The polymer coating (polyethylene type) allows heat bonding of the periphery of layers 2, 3 on reinforcement 5.

Of course, other materials can be used to constitute reinforcement 5, in particular a single coat reinforcement 5 in a plastic material.

It is characteristic of the invention that peripheral reinforcement 5 receives the marking identifying the type of package 1 used.

This marking is preferably of a predetermined colour which means a shade of colour that can be recognized and individualized by reading means or by a user.

According to a first possibility, the core of peripheral reinforcement 5 is coloured in the mass and the polymer plastic coatings are non opaque so that the colour of the core is visible.

According to another possibility, the core is coloured on each of its side or on one of them.

According to another possibility, the coatings covering the core with peripheral reinforcement 5 are themselves coloured in the mass or are coloured on one of their sides.

It will be noted that the execution of such a colour marking in or on the peripheral reinforcement 5 allows a continuous marking on all the periphery of package 1 to be easily provided so as to allow the shade of colour to be read whatever the orientation of package 1 relative to the reading means on the brewing device.

This is a very effective way of marking which allows package 1 to be manufactured in great quantities without significantly increasing the manufacturing costs.

Moreover, the applicant has noted that surprisingly, the formation of a colour marking on peripheral core 5 does not obstruct the detection of the colour in spite of the filter paper-based coating produced by layers 2 and 3.

Indeed, it has been shown that layers 2 and 3 are sufficiently transparent not to obstruct the reading of the colour.

According to another possibility, core 5 is not completely opaque so as to ensure the transmission of light according to its thickness. In this way, the colour can be detected by a transmitive reading system. In other cases, a reflective system (reflection of light on the coloured element and analysis of the reflected light) could be used.

### REFERENCES

1. Package
2. Upper layer
3. Lower layer
4. Substance to be brewed
5. Peripheral reinforcement
6. Peripheral seal

1. Package (1) for brewing a substance to be brewed comprising two filter paper-based layers (2, 3) superimposed so as to define a volume receiving the substance to be brewed (4) and joined each one to one side of a peripheral reinforcement (5), the aforementioned package (1) having marking for its identification, characterized in that the marking is made on at least one side of peripheral reinforcement (5).

2. Package (1) according to claim 1, characterized in that reinforcement (5) has a rigid core covered on both sides by a polymer plastic coating, the marking is of a predefined colour of the material used for at least one of the reinforcement (5) coatings.

3. Package (1) according to claim 1 characterized in that reinforcement (5) comprises of a rigid core covered on both sides by a non-opaque polymer plastic coating, with a marking provided on at least one side of the rigid core.

4. Package (1) according to claim 1 characterized in that the marking is a continuous strip of predefined colour on at least one side of reinforcement (5).

5. Package (1) according to claim 4 characterized in that the length of the strip is equal to that of reinforcement (5).

6. Package (1) according to claim 3 characterized in that the marking is in a predefined colour of the rigid core material.

7. Package (1) according to claim 1, characterized in that the marking is a predefined colour of the peripheral reinforcement (5) material.

8. Package (1) according to claim 1 characterized in that peripheral reinforcement (5) is not opaque.

9. Package (1) according to claim 3 characterized in that the marking is a continuous strip of predefined colour on at least one side of reinforcement (5).

10. Package (1) according to claim 9 characterized in that the length of the strip is equal to that of reinforcement (5).
